(19) United States
(12) Patent Application Publication
(10) Pub. No.: US 2020/0108717 A1
(43) Pub. Date: Apr. 9, 2020

(54) APPARATUS AND METHOD FOR CONTROLLING SPEED

(71) Applicant: MANDO CORPORATION, Pyeongtaek-si (KR)

(72) Inventor: InHo KIM, Seoul (KR)

(21) Appl. No.: 16/595,825

(22) Filed: Oct. 8, 2019

(30) Foreign Application Priority Data
Oct. 8, 2018 (KR) 10-2018-0120082

(51) Int. Cl. B60K 31/18; B60W 30/14; B60W 40/105; B60W 40/09; B60W 40/04

(52) U.S. Cl. CPC B60K 31/18; B60W 30/146; B60W 40/04; B60W 40/09; B60W 40/105

(57) ABSTRACT

The present disclosure relates to a speed control apparatus and a speed control method. Specifically, the present disclosure provides a speed control apparatus including: a driver propensity data manager configured to store acceleration and a speed change completion position per speed limit zone type as driver propensity data in the state in which a forward vehicle following function is not activated; a speed limit zone type determinator configured to determine a type of a speed limit zone using navigation information; a speed comparator configured to determine whether the current speed of a vehicle is greater than a speed limit in the speed limit zone according to the type of the speed limit zone; and a speed controller configured to identify acceleration and a speed change completion position corresponding to the speed limit zone from the driver propensity data according to the type of the speed limit zone and to control the speed of the vehicle by calculating a speed change start position of the vehicle using the acceleration and the speed change completion position when the current speed of the vehicle is greater than the speed limit in the speed limit zone.

### CROSS REFERENCE TO RELATED APPLICATION

This application claims priority from Korean Patent Application No. 10-2018-0120082, filed on Oct. 8, 2018, which is hereby incorporated by reference for all purposes as if fully set forth herein.

### BACKGROUND OF THE INVENTION

### 1. Field of the Invention

The present disclosure relates to a speed control apparatus and a speed control method, and more particularly, to a speed control apparatus and a speed control method that learn a driver's driving habits in respective speed limit zone types and perform speed control based on learned driver propensity data.

### 2. Description of the Prior Art

As a car has become a necessity for people today, there is growing demand for technology for enhancing the convenience and safety of a car driver. Therefore, a Driver-Assistance-System (DAS) technology is continuously being studied and developed.

As a DAS technology, there is a Smart Cruise Control (SCC) technology. The SCC technology is a DAS technology that automatically controls the speed of a vehicle at a speed set by the driver in the absence of a preceding vehicle but controls a vehicle to cruise at a constant distance from a preceding vehicle in the presence of such a preceding vehicle.

However, a vehicle employing SCC technology cannot adaptively control the vehicle speed in consideration of the driving environment of the vehicle, such as speed enforcement, section control, or curvature of the road being driven. In addition, when controlling the speed of a vehicle by applying SCC technology, the driver's driving habits and individual propensities are not considered for vehicle control. Thus, the speed control mode of the vehicle does not match the driver's driving habits, thus causing a sensation of disaccord.

### SUMMARY OF THE INVENTION

With this background, an aspect of the present disclosure is to provide a driving function reflecting the driving habits of a driver in a speed limit zone.

In accordance with an aspect of the present disclosure, there is provided a speed control apparatus including: an image sensor configured to be disposed in a vehicle to have a view of an outside of the vehicle and to capture image data; and a controller configured to include a processor configured to process the image data captured by the image sensor, wherein the controller includes: a driver propensity data manager configured to store acceleration and a speed change completion position per speed limit zone type as driver propensity data in the state in which a forward vehicle following function based at least partly on processing of the image data captured by the image sensor is not activated; a speed limit zone type determinator configured to determine the type of a speed limit zone using navigation information; a speed comparator configured to determine whether the current speed of the vehicle is greater than a speed limit in the speed limit zone according to the type of the speed limit zone; and a speed controller configured to identify acceleration and a speed change completion position corresponding to the speed limit zone from the driver propensity data according to the type of the speed limit zone and to control the speed of the vehicle by calculating a speed change start position of the vehicle using the acceleration and the speed change completion position when the current speed of the vehicle is greater than the speed limit in the speed limit zone.

In accordance with another aspect of the present disclosure, there is provided a speed control method including: a driver propensity data management operation of storing acceleration and a speed change completion position per speed limit zone type as driver propensity data in the state in which a forward vehicle following function is not activated; a speed limit zone type determination operation of determining the type of a speed limit zone using navigation information; a speed comparison operation of determining whether the current speed of a vehicle is greater than a speed limit in the speed limit zone according to the type of the speed limit zone; and a speed control operation of identifying acceleration and a speed change completion position corresponding to the speed limit zone from the driver propensity data according to the type of the speed limit zone and of controlling the speed of the vehicle by calculating a speed change start position of the vehicle using the acceleration and the speed change completion position when the current speed of the vehicle is greater than the speed limit in the speed limit zone.

In accordance with still another aspect of the present disclosure, there is provided a speed control apparatus including: an image sensor configured to be disposed in a vehicle to have a view of an outside of the vehicle and to capture image data; and an integrated controller configured to process the image data captured by the image sensor and to control a forward vehicle following function, wherein the integrated controller stores acceleration and a speed change completion position per speed limit zone type as driver propensity data in the state in which a forward vehicle following function based at least partly on processing of the image data captured by the image sensor is not activated, determines the type of a speed limit zone using navigation information, determines whether the current speed of the vehicle is greater than a speed limit in the speed limit zone according to the type of the speed limit zone, identifies acceleration and a speed change completion position corresponding to the speed limit zone from the driver propensity data according to the type of the speed limit zone, and controls the speed of the vehicle by calculating a speed change start position of the vehicle using the acceleration and the speed change completion position when the current speed of the vehicle is greater than the speed limit in the speed limit zone.

In accordance with yet another aspect of the present disclosure, there is provided a speed control apparatus including: a driver propensity data manager configured to store acceleration and a speed change completion position per speed limit zone type as driver propensity data in the state in which a forward vehicle following function is not activated; a speed limit zone type determinator configured to determine the type of a speed limit zone using navigation information; a speed comparator configured to determine whether the current speed of a vehicle is greater than a speed limit in the speed limit zone according to the type of the speed limit zone; and a speed controller configured to identify acceleration and a speed change completion position corresponding to the speed limit zone from the driver propensity data according to the type of the speed limit zone and to control the speed of the vehicle by calculating a speed change start position of the vehicle using the acceleration and the speed change completion position when the current speed of the vehicle is greater than the speed limit in the speed limit zone.

As described above, according to the present disclosure, a speed control start position and acceleration may be designated in consideration of the driver's driving habits according to the type of a speed limit zone, thereby providing a speed control method that matches the driver's driving habits. Thus, it is possible to reduce the sensation of disaccord in vehicle driving and improve sensitivity in driving.

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates the configuration of a speed control apparatus according to one embodiment of the present disclosure;

FIG. 2 illustrates a speed change start position for a speed-camera speeding detection point according to one embodiment of the present disclosure;

FIG. 3 illustrates a speed change completion position for a speed-camera speeding detection point according to one embodiment of the present disclosure;

FIG. 4 illustrates a speed change start position for the start position of a section control zone according to one embodiment of the present disclosure;

FIG. 5 illustrates a speed change completion position for the start position of a section control zone according to one embodiment of the present disclosure;

FIG. 6 illustrates a speed change start position for the end position of a section control zone according to one embodiment of the present disclosure;

FIG. 7 illustrates a speed change completion position for the end position of a section control zone according to one embodiment of the present disclosure;

FIG. 8 illustrates a speed change start position for a curve zone according to one embodiment of the present disclosure;

FIG. 9 illustrates a speed change completion position in a curve zone according to one embodiment of the present disclosure;

FIG. 10 is a flowchart illustrating a speed control method according to one embodiment of the present disclosure; and

FIG. 11 is a flowchart illustrating a speed control operation according to one embodiment of the present disclosure.

### DETAILED DESCRIPTION OF THE EXEMPLARY EMBODIMENTS

The present disclosure discloses a speed control apparatus and a speed control method.

Hereinafter, embodiments of the present disclosure will be described in detail with reference to the accompanying drawings. In the description of the elements of the present disclosure, terms “first”, “second”, “A”, “B”, “(a)”, “(b)” and the like may be used. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

The speed control apparatus of the present disclosure refers to a controller that is provided in a vehicle having a forward vehicle following function, collects driver propensity data in the state in which the forward vehicle following function is not activated, and controls the speed of the vehicle in the state in which the forward vehicle following function is activated. For example, the speed control apparatus may refer to a Main Control Unit (MCU), an Electronic Control Unit (ECU), or a CPU of the vehicle or may refer to some of the functions of the MCU or the CPU.

Here, the forward vehicle following function refers to a function that automatically controls the vehicle to run at a speed set by the driver when there is no vehicle ahead and that maintains a constant distance from a preceding vehicle through distance control using a radar sensor when there is a vehicle ahead. The forward vehicle following function includes Smart Cruise Control (SCC) or Navigation-based Smart Cruise Control (NSCC).

A function of detecting a vehicle nearby a vehicle in the forward vehicle following function may be performed using at least one of an image sensor and a non-image sensor.

The image sensor may be a vehicular image sensor represented by a camera, an image system, or a vision system. The vehicular image sensor may include a front camera having a front view from the vehicle, a rear camera having a rear view from the vehicle, and a rear-lateral camera having a lateral view or rear-lateral view from the vehicle, and may selectively include one or more of these cameras oriented in a plurality of directions as necessary.

These cameras function to capture image data of the surroundings of the vehicle and to transmit the image data to a processor or a controller. The vision system or the image sensor according to the present embodiment may further include an ECU or an image processor that functions to process captured image data and to display the image data on a display.

The vision system or the image sensor may further include an appropriate data link or communication link, such as a vehicle network bus, for data transmission or signal communication from the camera to the image processor.

The non-image sensor may include a radar sensor, a lidar sensor, or an ultrasonic sensor. The non-image sensor is disposed in the vehicle and performs a function of capturing sensing data in order to sense one of objects around the vehicle. Specifically, the non-image sensor refers to a sensor that transmits electromagnetic waves, such as radar waves or ultrasonic waves, and receives and analyzes a signal reflected from a target object to thereby calculate information such as the distance to the target object and the position.

Hereinafter, the speed control apparatus and the speed control method according to the present disclosure will be described in detail with reference to the drawings.

The speed control apparatus of the present disclosure includes an image sensor configured to be disposed in a vehicle to have a view of an outside of the vehicle and to capture image data and a controller configured to include a processor configured to process the image data captured by the image sensor.

As described above, the image sensor may be used to capture information on the surroundings of the vehicle and an object when performing the forward vehicle following function of the vehicle. A detailed description of the image sensor may correspond to the foregoing description of the image sensor of the forward vehicle following function.

Specifically, the controller includes: a driver propensity data manager that stores acceleration and a speed change completion position per speed limit zone type as driver propensity data in the state in which the forward vehicle following function is not activated; a speed limit zone type determinator that determines the type of a speed limit zone using navigation information; a speed comparator that determines whether the current speed of the vehicle is greater than a speed limit in a speed limit zone according to the type of the speed limit zone; and a speed controller that identifies acceleration and a speed change completion position corresponding to the speed limit zone from the driver propensity data according to the type of the speed limit zone and controls the speed of the vehicle by calculating the speed change start position of the vehicle using the acceleration and the speed change completion position when the current speed of the vehicle is greater than the speed limit in the speed limit zone.

In one embodiment, the speed control apparatus may include a driver propensity data manager, a speed limit zone type determinator, a speed comparator, and a speed controller. Hereinafter, the speed control apparatus including the driver propensity data manager, the speed limit zone type determinator, the speed comparator, and the speed controller will be described.

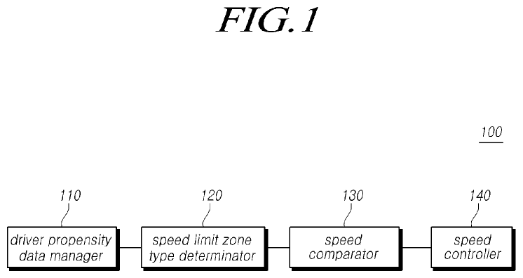

FIG. 1 illustrates the configuration of a speed control apparatus according to one embodiment of the present disclosure.

Referring to FIG. 1, the speed control apparatus 100 of the present disclosure includes a driver propensity data manager 110 that stores acceleration and a speed change completion position per speed limit zone type as driver propensity data in the state in which a forward vehicle following function is not activated.

The driver propensity data manager 110 collects and stores the driving habits of a driver according to the type of a speed limit zone as driver propensity data in the state in which the forward vehicle following function, such as Smart Cruise Control (SCC) or Navigation-based Smart Cruise Control (NSCC), is not activated.

A vehicle may collect information on a speed limit zone using a sensor mounted on the vehicle, may receive the information on the speed limit zone from the infrastructure using vehicle-to-infrastructure (V2I) communication, or may check the information on the speed limit zone using navigation information.

The sensor used to collect the information on the speed limit zone may include an image sensor configured to be disposed in a vehicle to have a view of an outside of the vehicle and to capture image data. The image sensor may include the image sensor used for the forward vehicle following function described above. A detailed description of the image sensor may correspond to the foregoing description of the image sensor of the forward vehicle following function.

V2I communication used to receive the information on the speed limit zone may be performed using a V2X communication module. The V2X communication module is a module for performing wireless communication with a server or a road infrastructure. The V2X module includes a module capable of implementing a V2I communication protocol. The vehicle may perform wireless communication with an external server and an infrastructure server through the V2X communication module.

In a vehicle-to-infrastructure telematics system, connected vehicles mutually interact with V2I and V2X via, for example, wireless communication. 3G/4G cellular communication, Wi-Fi communication, and 5.9-GHz Dedicated Short-Range Communication (DSRC) may be used to provide situational awareness, collision avoidance, and post-accident assistance for vehicle drivers on a road. Such a car2X (V2X) communication system can wirelessly transmit data from a host vehicle to an infrastructure system (e.g., a speed limit zone management system, a traffic light control system, or a traffic management system) using telematics. Data may be telematically delivered to the host vehicle from the infrastructure system or the like. The data may include speed limit zone data, traffic condition data, traffic density data, weather data, road condition data, and/or the like.

As a speed limit zone type, there are a speeding detection zone by a speed camera and a curve zone. The speeding detection zone by the speed camera may be one point, which may be a speeding detection point at which it is determined whether the vehicle exceeds a specified speed, thereby determining whether the vehicle speeds. Alternatively, the speeding detection zone by the speed camera may be a section control zone in which the average speed of the vehicle according to the distance from the start position of the zone to the end position of the zone is calculated based on the passing time and the passing speed at the start position of the zone using speed cameras installed at the start position and the end position of the zone and it is determined whether the average speed exceeds a specified speed, thereby determining whether the vehicle speeds. The curve zone indicates a road that is not straight and refers to an area where a vehicle is recommended to run at a certain speed or less, determined depending on the curvature of curves in the road.

For example, when there is a speed-camera speeding detection zone on a road where the vehicle is running in the state in which the forward vehicle following function is not activated, the driver propensity data manager 110 stores the acceleration and the speed change completion position of the vehicle driven by the driver as driver propensity data in the speed-camera speeding detection zone. Specifically, when the speed-camera speeding detection zone is a speeding detection point, the speed control apparatus stores the acceleration and the speed change completion position of the vehicle in the speeding detection zone, in which the speed change completion position is a position that is a certain distance apart from one point where speeding is determined. When the speed-camera speeding detection zone is a section control zone, the speed control apparatus stores the acceleration and the speed change completion position for each of the start position and the end position of the section control zone.

In another example, when there is a curve zone on a road where the vehicle is running in the state in which the forward vehicle following function is not activated, the driver propensity data manager 110 stores the acceleration and the speed change completion position of the vehicle driven by the driver as driver propensity data in the curve zone. Here, the speed change completion position is a position that is a certain distance apart from the start position of the speed limit zone.

In one embodiment of the present disclosure, the driver propensity data manager 110 collects speed change time, speed variation, and a speed change completion position per speed limit zone type in the state in which the forward vehicle following function is not activated, calculates acceleration per speed limit zone type from the speed change time and the speed variation per speed limit zone type, and stores the acceleration and the speed change completion position per speed limit zone type as driver propensity data.

The speed change time is a time interval from the time when the vehicle reduces speed at the speed change start position to the time when the vehicle reaches a speed limit of a speed limit zone at a speed change completion position. The speed variation is a speed difference value between the speed at which the vehicle runs at or immediately before a speed change start position and the speed at which the vehicle runs at a speed change completion position, that is, a speed difference value between the speed at which the vehicle runs at or immediately before the speed change start position and a speed limit of a speed limit zone. The speed change completion position is a position that is a certain distance apart from the start position of a speed limit zone, as described above, and indicates the position where the speed of the vehicle reaches a speed limit of the speed limit zone. A speed change start position is a position that is a certain distance apart from the start position of a speed limit zone and indicates the position where the vehicle starts to reduce the running speed so that the speed of the vehicle reaches the speed limit of the speed limit zone after detecting the speed limit zone on a road where the vehicle is running and sensing that the running speed of the vehicle is greater than the speed limit of the speed limit zone.

The driver propensity data manager 110 calculates acceleration using the collected speed change time and speed variation. The driver propensity data manager 110 may categorize speed limit zones in advance according to type and may collect speed change time, speed variation, and a speed change completion position according to each type, thus calculating acceleration for each type. The driver propensity data manager 110 may categorize the calculated acceleration per speed limit zone type and the collected speed change completion position according to the type of a speed limit zone and may store the acceleration and the speed change completion position as driver propensity data.

When a speed limit zone is a section control zone, the speed control apparatus collects a speed change time, speed variation, and speed change completion position with respect to each of the start position of the section control zone and the end position of the section control zone after entering the section control zone. In this case, when collecting data before the end position of the section control zone, the speed control apparatus applies the average running speed of the vehicle after entering the section control zone and the current running speed instead of the current running speed of the vehicle.

In one embodiment of the present disclosure, the driver propensity data manager 110 stores the acceleration and the speed change completion position according to each speed limit zone type using a moving average method. When a speed limit zone is a speed-camera speeding detection zone, the driver propensity data manager 110 may store acceleration and a speed change completion position per speed limit of a speed limit zone according to the speed limit range of a speed limit zone. The driver propensity data manager 110 may store acceleration and a speed change completion position per speed difference according to the difference between the current speed of the vehicle and a speed limit in a speed limit zone. When a speed limit zone is a curve zone, the driver propensity data manager 110 may store acceleration and a speed change completion position per curve zone shape according to the shape of the curve zone. Here, the acceleration and the speed change completion position may be stored using the moving average method. When the moving average method is used, it is possible to accumulatively reflect a change when a new speed change time, new speed variation, and a new speed change completion position are collected in the state in which the forward vehicle following function is not activated. Accordingly, it is possible to adapt to the evolving direction of the driver's driving habits.

The speed control apparatus 100 of the present disclosure includes a speed limit zone type determinator 120 that determines the type of a speed limit zone using navigation information in the state in which the forward vehicle following function, such as SCC or NSCC, is activated. The speed control apparatus may receive the navigation information using wireless communication. The speed limit zone type determinator 120 may determine the presence or absence of a speed camera and the curvature of the driving road based on the navigation information. When it is determined that there is a speed camera on the driving road based on the navigation information, the speed limit zone type determinator 120 determines that the speed limit zone is a speed-camera speeding detection zone. When it is determined that the driving road is a curved road having a curvature based on the navigation information, the speed limit zone type determinator 120 determines that the speed limit zone is a curve zone.

The speed control apparatus 100 of the present disclosure includes a speed comparator 130 that determines whether the current speed of the vehicle is greater than a speed limit in a speed limit zone according to the type of the speed limit zone. When the type of a speed limit zone is determined by the speed limit zone type determinator 120, a speed limit in the speed limit zone may be determined.

In one embodiment of the present disclosure, when it is determined that the speed limit zone is a speed-camera speeding detection zone, the speed comparator 130 extracts a speed limit in the speed-camera speeding detection zone from navigation information and sets the extracted speed limit as a speed limit in the speed limit zone.

In another embodiment of the present disclosure, when it is determined that the type of the speed limit zone is a curve zone, the speed comparator 130 extracts the curvature of a curved road from navigation information, determines a speed limit for the curvature based on a speed limit table according to a preset curvature, and sets the speed limit for the curvature as a speed limit in the speed limit zone.

The speed control apparatus 100 of the present disclosure includes a speed controller 140 that identifies acceleration and a speed change completion position corresponding to the speed limit zone from the driver propensity data according to the type of the speed limit zone and controls the speed of the vehicle by calculating the speed change start position of the vehicle using the acceleration and the speed change completion position when the current speed of the vehicle is greater than the speed limit in the speed limit zone.

When the current speed of the vehicle is greater than the speed limit in the speed limit zone, the speed controller 140 determines that speed control is needed to reduce the speed of the vehicle to the speed limit in the speed limit zone or less. The speed controller 140 extracts acceleration and a speed change completion position corresponding to the speed limit zone from the driver propensity data per speed limit zone type stored by the driver propensity data manager 110. The speed controller 140 calculates a speed change start position using the acceleration and the speed change completion position corresponding to the speed limit zone and controls the speed of the vehicle.

In one embodiment of the present disclosure, the speed controller 140 calculates the speed change start position using the current speed of the vehicle, the speed limit in the speed limit zone, and the acceleration and the speed change completion position corresponding to the speed limit zone, and controls the speed of the vehicle when the vehicle reaches the speed change start position.

The speed change start position may be calculated using Equation 1:

Speed change start position={(current speed of vehicle+speed limit in speed limit zone)×speed change time×1/2}+speed change completion position. [Equation 1]

The speed change time may be calculated using Equation 2:

Speed change time=(current speed of vehicle−speed limit in speed limit zone)/acceleration. [Equation 2]

Here, the speed change time indicates the time taken for the vehicle to reach the speed limit in the speed limit zone from the current speed of the vehicle.

The driver propensity data manager 110, the speed limit zone type determinator 120, the speed comparator 130, and the speed controller 140 described above may be integrated to function as a single controller.

The controller or integrated controller may include a processor that processes image data captured by a camera. The controller may operate to perform the forward vehicle following function based at least partly on processing of image data captured by an image sensor.

Further, the controller or integrated controller according to the present embodiment may be configured as a Domain Control Unit (DCU) having a function of receiving and processing information on a plurality of vehicle sensors or a function of mediating transmission and reception of sensor signals and the forward vehicle following function, a function of determining a speed limit zone, and a vehicle speed control function according to the present embodiment in an integrated manner, but is not limited thereto.

This integrated controller (DCU) may function to: process the image data captured by the image sensor; store acceleration and a speed change completion position per speed limit zone type as driver propensity data in the state in which the forward vehicle following function based at least partly on processing of the image data captured by the image sensor is not activated; determine the type of the speed limit zone using navigation information; determine whether the current speed of the vehicle is greater than the speed limit in the speed limit zone according to the type of the speed limit zone; check acceleration and a speed change completion position corresponding to the speed limit zone from the driver propensity data according to the type of the speed limit zone when the current speed of the vehicle is greater than the speed limit in the speed limit zone; and control the speed of the vehicle by calculating the speed change start position of the vehicle using the acceleration and the speed change completion position. According to the present disclosure, the speed control apparatus stores the driver's driving habits (acceleration and a speed change completion position) as driver propensity data according to the type of the speed limit zone in the state in which the forward vehicle following function is not activated, and performs speed control by calculating a speed change start position using driver propensity data according to the type of the speed limit zone when there is a speed limit zone. The present disclosure may designate a speed control start position and acceleration in consideration of the driver's driving habits according to the type of a speed limit zone, thereby providing a speed control method that matches the driver's driving habits. Thus, it is possible to reduce a sensation of disaccord in vehicle driving and improve sensitivity in driving.

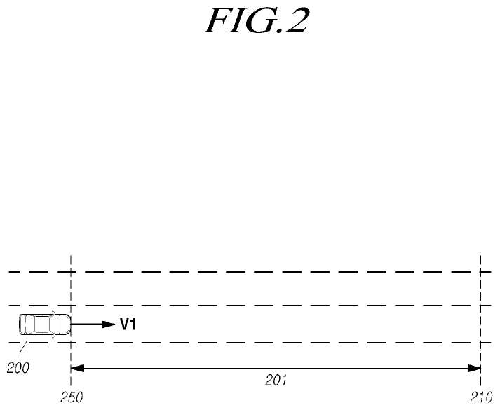

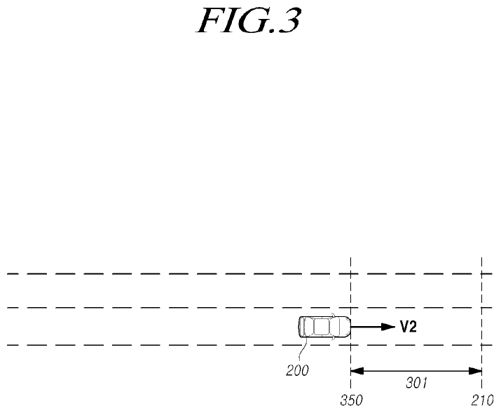

FIGS. 2 and 3 illustrate a process for performing speed control when a speed limit zone is a speed-camera speeding detection zone and speeding is determined at one point. FIG. 2 illustrates a speed change start position for the speed-camera speeding detection point, where a vehicle 200 is positioned to start speed control, according to one embodiment of the present disclosure. FIG. 3 illustrates a speed change completion position for the speed-camera speeding detection point, where the vehicle 200 completes deceleration by adjusting the driving speed to a speed limit in the section control, according to one embodiment of the present disclosure.

The vehicle 200 is running at speed V1 on a road in the state in which a forward vehicle following function is activated. When it is detected that there is a speed-camera speeding detection point ahead during driving, the vehicle 200 checks a speed limit (V2) of the speed-camera speeding detection point ahead. Information on the speed limit zone and information on the speed limit in the speed limit zone may be extracted from navigation information. When it is determined that the current running speed (V1) of the vehicle is greater than the speed limit (V2) in the speed-camera speeding detection point, the vehicle 200 may control the speed using stored driver propensity data per speed limit zone type so that the running speed of the vehicle is the speed limit in the speed-camera speeding detection point or lower. In this case, the vehicle 200 checks acceleration and a speed change completion position 350 collected for the speed-camera speeding detection point from the driver propensity data and calculates a speed change start position 250 using the checked acceleration and speed change completion position. When the vehicle 200 reaches the calculated speed change start position 250, the vehicle 200 starts to control the speed. Here, the speed change completion position 350 is a position spaced a certain distance 301 from the start position 210 of the speed-camera speeding detection point, and the speed change start position 250 is a position spaced a certain distance 201 from the start position 210 of the speed-camera speeding detection point. The speed change start position 250 may be calculated using the current running speed, the speed limit in the speed-camera speeding detection point, and the previously checked acceleration and speed change completion position 350.

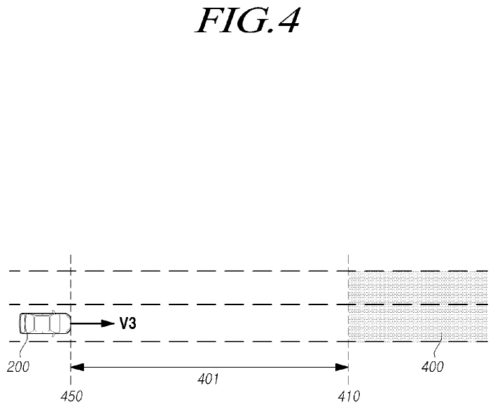

FIGS. 4 to 7 illustrate a process for performing speed control when a speed limit zone is a speed-camera speeding detection zone, which is a section control zone.

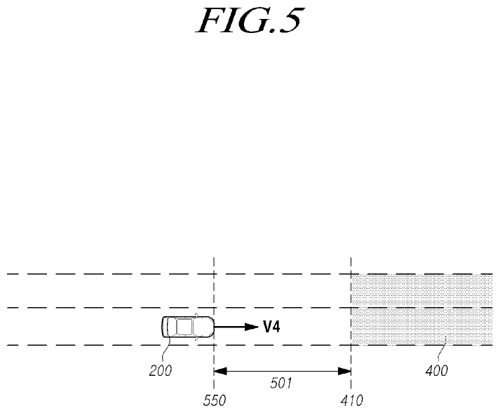

FIG. 4 illustrates a speed change start position for the start position of the section control zone, where a vehicle 200 is positioned to start speed control, according to one embodiment of the present disclosure. FIG. 5 illustrates a speed change completion position for the start position of the section control zone, where the vehicle 200 completes deceleration by adjusting the driving speed to a speed limit in the section control, according to one embodiment of the present disclosure.

The vehicle 200 is running at speed V3 on a road in the state in which a forward vehicle following function is activated. When it is detected that there is a section control zone 400 ahead during driving, the vehicle 200 checks a speed limit (V4) in the section control zone. Information on the section control zone and information on the speed limit in the section control zone may be extracted from navigation information. When it is determined that the current running speed (V3) of the vehicle is greater than the speed limit (V4) in the section control zone, the vehicle 200 may control the speed using stored driver propensity data per speed limit zone type so that the running speed of the vehicle is the speed limit in the section control zone or less. In this case, the vehicle 200 checks acceleration and a speed change completion position 550 collected for the start position of the section control zone from the driver propensity data and calculates a speed change start position 450 using the checked acceleration and speed change completion position 550. When the vehicle 200 reaches the calculated speed change start position 450, the vehicle 200 starts to control the speed. Here, the speed change completion position 550 is a position spaced a certain distance 501 from the start position 410 of the section control zone, and the speed change start position 450 is a position a certain distance 401 from the start position 410 of the section control zone. The speed change start position 450 may be calculated using the current running speed, the speed limit in the section control zone, and the previously checked acceleration and speed change completion position 550.

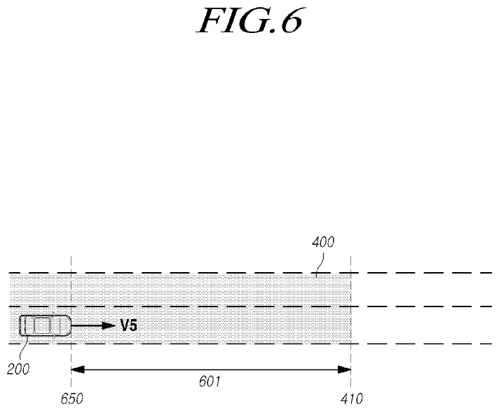

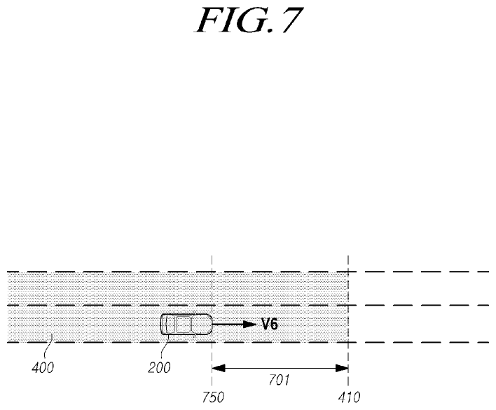

FIG. 6 illustrates a speed change start position for the end position of the section control zone, where a vehicle 200 is positioned to start speed control, according to one embodiment of the present disclosure. FIG. 7 illustrates a speed change completion position for the end position of the section control zone, in which the vehicle 200 completes deceleration by adjusting the driving speed to a speed limit in the section control zone, according to one embodiment of the present disclosure.

The vehicle 200 is running at a running speed V5 and an average speed V7 (not shown) in the section control zone on a road in the state in which the forward vehicle following function is activated. The vehicle 200 checks a speed limit (V6) in the section control zone. Information on the section control zone and information on the speed limit in the section control zone may be extracted from navigation information. When it is determined that the current running speed (V5) or the average speed of the vehicle is greater than the speed limit (V6) in the section control zone, the vehicle 200 may control the speed using stored driver propensity data per speed limit zone type so that the running speed and the average speed of the vehicle are the speed limit in the section control zone or less. In this case, the vehicle 200 checks acceleration and a speed change completion position 750 collected for the end position of the section control zone from the driver propensity data and calculates a speed change start position 650 using the checked acceleration and speed change completion position 750. When the vehicle 200 reaches the calculated speed change start position 650, the vehicle 200 starts to control the speed. Here, the speed change completion position 750 is a position spaced a certain distance 701 from the end position 610 of the section control zone, and the speed change start position 650 is a position spaced a certain distance 601 from the end position 610 of the section control zone. The speed change start position 650 may be calculated using the current running speed, the average running speed, the speed limit in the section control zone, and the previously checked acceleration and speed change completion position 750.

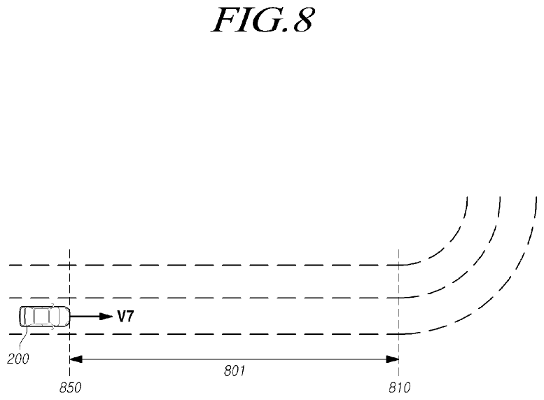

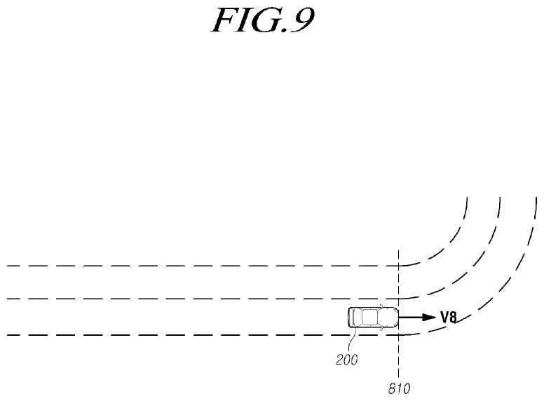

FIG. 8 illustrates a speed change start position for a curve zone, where a vehicle 200 is positioned to start speed control, according to one embodiment of the present disclosure. FIG. 9 illustrates a speed change completion position for the curve zone, where the vehicle 200 completes deceleration by adjusting the driving speed to a speed limit in the speed limit zone, according to one embodiment of the present disclosure.

The vehicle 200 is running at speed V7 on a road in the state in which a forward vehicle following function is activated. When it is detected that there is a curve zone ahead during driving, the vehicle 200 checks a speed limit (V8) in the curve zone ahead. Information on a speed limit zone and information on a speed limit in the speed limit zone may be extracted from navigation information. Alternatively, information on the curve zone may be extracted from the navigation information, and a speed limit in the curve zone may be determined according to a speed limit table based on a preset curvature. When it is determined that the current running speed (V7) of the vehicle in the speed limit zone is greater than the speed limit (V8) in the curve zone, the vehicle 200 may control the speed using stored driver propensity data per speed limit zone type so that the running speed of the vehicle is the speed limit in the curve zone or less. In this case, the vehicle 200 checks acceleration and a speed change completion position collected for the curve zone from the driver propensity data and calculates a speed change start position 850 using the checked acceleration and speed change completion position. When the vehicle 200 reaches the calculated speed change start position 850, the vehicle 200 starts to control the speed. Here, the speed change completion position 810 is a position spaced a certain distance apart from the curve zone, in which the speed change completion position 810 is stored in the same manner as the start position of the curve zone. The speed change start position 850 is a position spaced a certain distance 801 apart from the curve zone. The speed change start position 850 may be calculated using the current running speed, the speed limit in the curve zone, and the previously checked acceleration and speed change completion position.

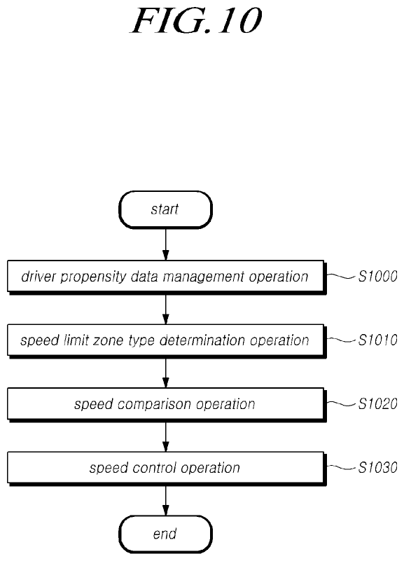

FIG. 10 is a flowchart illustrating a speed control method according to one embodiment of the present disclosure.

The speed control method of the present disclosure includes: a driver propensity data management operation of storing acceleration and a speed change completion position per speed limit zone type as driver propensity data in the state in which the forward vehicle following function is not activated; a speed limit zone type determination operation of determining the type of a speed limit zone using navigation information; a speed comparison operation of determining whether the current speed of the vehicle is greater than a speed limit in a speed limit zone according to the type of the speed limit zone; and a speed control operation of identifying acceleration and a speed change completion position corresponding to the speed limit zone from the driver propensity data according to the type of the speed limit zone and of controlling the speed of the vehicle by calculating the speed change start position of the vehicle using the acceleration and the speed change completion position when the current speed of the vehicle is greater than the speed limit in the speed limit zone.

Referring to FIG. 10, the speed control method of the present disclosure includes the driver propensity data management operation of storing acceleration and a speed change completion position per speed limit zone type as driver propensity data in the state in which a forward vehicle following function is not activated (S1000).

For example, when there is a speed-camera speeding detection zone on a road where the vehicle is running in the state in which the forward vehicle following function is not activated, a speed control apparatus stores the acceleration and the speed change completion position of the vehicle driven by the driver as driver propensity data in the speed-camera speeding detection zone. Specifically, when the speed-camera speeding detection zone is a speeding detection point, the speed control apparatus stores the acceleration and the speed change completion position of the vehicle in the speeding detection zone, in which the speed change completion position is a position that is a certain distance apart from one point where speeding is determined. When the speed-camera speeding detection zone is a section control zone, the speed control apparatus stores the acceleration and the speed change completion position for each of the start position and the end position of the section control zone.

In another example, when there is a curve zone on a road where the vehicle is running in the state in which the forward vehicle following function is not activated, the speed control apparatus stores the acceleration and the speed change completion position of the vehicle driven by the driver as driver propensity data in the curve zone. Here, the speed change completion position is a position that is a certain distance apart from the start position of the speed limit zone.

In one embodiment of the present disclosure, the speed control apparatus collects speed change time, speed variation, and a speed change completion position per speed limit zone type in the state in which the forward vehicle following function is not activated, calculates acceleration per speed limit zone type from the speed change time and the speed variation per speed limit zone type, and stores the acceleration and the speed change completion position per speed limit zone type as driver propensity data.

The speed control apparatus calculates acceleration using the collected speed change time and speed variation. The speed control apparatus may categorize speed limit zones in advance according to type and may collect a speed change time, speed variation, and a speed change completion position according to each type, thus calculating acceleration by each type. The speed control apparatus may categorize the calculated acceleration per speed limit zone type and the collected speed change completion position according to the type of a speed limit zone and may store the acceleration and the speed change completion position as driver propensity data.

When a speed limit zone is a section control zone, the speed control apparatus collects a speed change time, speed variation, and a speed change completion position with respect to each of the start position of the section control zone and the end position of the section control zone after entering the section control zone. In this case, when collecting data before the end position of the section control zone, the speed control apparatus applies the average running speed of the vehicle after entering the section control zone instead of the current running speed of the vehicle. In one embodiment of the present disclosure, the speed control apparatus stores the acceleration and the speed change completion position according to each speed limit zone type using a moving average method. When a speed limit zone is a speed-camera speeding detection zone, the speed control apparatus may store acceleration and a speed change completion position per speed limit of a speed limit zone according to the speed limit range of a speed limit zone. The speed control apparatus may store acceleration and a speed change completion position per speed difference according to the difference between the current speed of the vehicle and a speed limit in a speed limit zone. When a speed limit zone is a curve zone, the speed control apparatus may store acceleration and a speed change completion position per curve zone shape according to the shape of the curve zone. Here, the acceleration and the speed change completion position may be stored using the moving average method. When the moving average method is used, it is possible to accumulatively reflect a change when a new speed change time, new speed variation, and a new speed change completion position are collected in the state in which the forward vehicle following function is not activated. Accordingly, it is possible to adapt to the evolving direction of the driver's driving habits.

The speed control method of the present disclosure includes the speed limit zone type determination operation of determining the type of a speed limit zone using navigation information (S1010). The speed control apparatus may receive the navigation information using wireless communication. The speed control apparatus may determine the presence or absence of a speed camera and the curvature of the driving road based on the navigation information. When it is determined that there is a speed camera on the driving road based on the navigation information, the speed control apparatus determines that the speed limit zone is a speed-camera speeding detection zone. When it is determined that the driving road is a curved road having a curvature based on the navigation information, the speed control apparatus determines that the speed limit zone is a curve zone.

The speed control method of the present disclosure includes a speed comparison operation of determining whether the current speed of the vehicle is greater than a speed limit in a speed limit zone according to the type of the speed limit zone (S1020). When the type of a speed limit zone is determined by the speed control apparatus, a speed limit in the speed limit zone may be determined.

In one embodiment of the present disclosure, when it is determined that the speed limit zone is a speed-camera speeding detection zone, the speed control apparatus extracts a speed limit in the speed-camera speeding detection zone from navigation information and sets the extracted speed limit as a speed limit in the speed limit zone.

In another embodiment of the present disclosure, when it is determined that the type of the speed limit zone is a curve zone, the speed control apparatus extracts the curvature of a curved road from navigation information, determines a speed limit for the curvature based on a speed limit table according to a preset curvature, and sets the speed limit for the curvature as a speed limit in the speed limit zone.

The speed control method of the present disclosure includes a speed control operation of identifying acceleration and a speed change completion position corresponding to the speed limit zone from the driver propensity data according to the type of the speed limit zone and of controlling the speed of the vehicle by calculating the speed change start position of the vehicle using the acceleration and the speed change completion position when the current speed of the vehicle is greater than the speed limit in the speed limit zone (S1030).

When the current speed of the vehicle is greater than the speed limit in the speed limit zone, the speed control apparatus determines that speed control is needed to reduce the speed of the vehicle to the speed limit in the speed limit zone or less. The speed control apparatus extracts acceleration and a speed change completion position corresponding to the speed limit zone from the stored driver propensity data per speed limit zone type. The speed control apparatus calculates a speed change start position using the acceleration and the speed change completion position corresponding to the speed limit zone and controls the speed of the vehicle.

In one embodiment of the present disclosure, the speed control apparatus calculates the speed change start position using the current speed of the vehicle, the speed limit in the speed limit zone, and the acceleration and the speed change completion position corresponding to the speed limit zone, and controls the speed of the vehicle when the vehicle reaches the speed change start position.

According to the present disclosure, the speed control apparatus stores the driver's driving habits (acceleration and a speed change completion position) as driver propensity data according to the type of a speed limit zone in the state in which the forward vehicle following function is not activated, and performs speed control by calculating a speed change start position using driver propensity data according to the type of a speed limit zone when there is a speed limit zone. The present disclosure may designate a speed control start position and acceleration in consideration of the driver's driving habits according to the type of a speed limit zone, thereby providing a speed control method that matches the driver's driving habits. Thus, it is possible to reduce a sensation of disaccord in vehicle driving and improve sensitivity in driving.

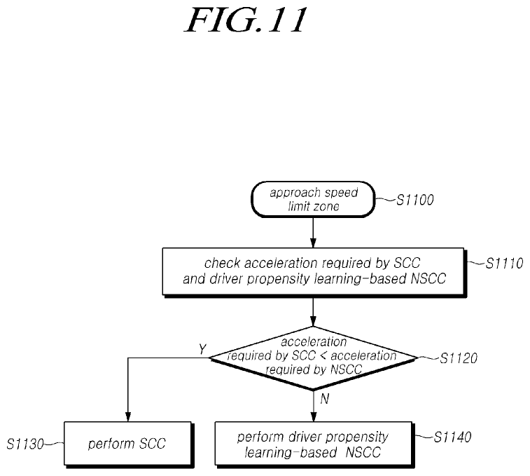

FIG. 11 is a flowchart illustrating a speed control operation according to one embodiment of the present disclosure.

A speed control apparatus of the present disclosure determines whether a vehicle approaches a speed limit zone (S1100). When it is determined that the vehicle is approaching the speed limit zone, the speed control apparatus checks the acceleration required by an SCC and the acceleration required by a driver propensity learning-based NSCC (S1110). The acceleration required by the SCC may be calculated using an algorithm that determines an increase or decrease in speed based on a set speed and the distance to a preceding vehicle. The acceleration required by the driver propensity learning-based NSCC may be extracted from driver propensity data stored in the speed control apparatus. The speed control apparatus determines whether the acceleration required by the driver propensity learning-based NSCC is greater than the acceleration required by the SCC (S1120). When it is determined that the acceleration required by the driver propensity learning-based NSCC is not greater than the acceleration required by the SCC, the speed control apparatus performs speed control by the SCC (S1130). When it is determined that the acceleration required by the driver propensity learning-based NSCC is greater than the acceleration required by the SCC, the speed control apparatus performs speed control by the driver propensity learning-based NSCC (S1140).

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

The above description and the accompanying drawings provide an example of the technical idea of the present disclosure for illustrative purposes only. Those having ordinary knowledge in the technical field, to which the present disclosure pertains, will appreciate that various modifications and changes in form, such as combination, separation, substitution, and change of a configuration, are possible without departing from the essential features of the present disclosure. Therefore, the embodiments disclosed in the present disclosure are intended to illustrate the scope of the technical idea of the present disclosure, and the scope of the present disclosure is not limited by the embodiment. That is, at least two elements of all structural elements may be selectively joined and operate without departing from the scope of the present disclosure. The scope of the present disclosure shall be construed on the basis of the accompanying claims in such a manner that all of the technical ideas included within the scope equivalent to the claims belong to the present disclosure.

What is claimed is:

1. A speed control apparatus comprising:
an image sensor configured to be disposed in a vehicle to have a view of an outside of the vehicle and to capture image data; and
a controller comprising a processor configured to process the image data captured by the image sensor,
wherein the controller is configured to:
store acceleration and a speed change completion position per speed limit zone type as driver propensity data in a state in which a forward vehicle following function based at least partly on processing of the image data captured by the image sensor is not activated;
determine a type of a speed limit zone using navigation information;
determine whether a current speed of the vehicle is greater than a speed limit in the speed limit zone according to the type of the speed limit zone;
identify acceleration and a speed change completion position corresponding to the speed limit zone from the driver propensity data according to the type of the speed limit zone; and
perform speed control of the vehicle by calculating a speed change start position of the vehicle using the acceleration and the speed change completion position when the current speed of the vehicle is greater than the speed limit in the speed limit zone.

2. The speed control apparatus of claim 1, wherein each of the speed change start position and the speed change completion position is a position that is a certain distance apart from a start position of the speed limit zone.

3. The speed control apparatus of claim 1, wherein the speed limit zone is a speed-camera speeding detection zone or a curve zone.

4. The speed control apparatus of claim 3, wherein, when it is determined that the speed limit zone is the speed-camera speeding detection zone, the controller is configured to extract a speed limit in the speed-camera speeding detection zone from the navigation information and set the extracted speed limit as a speed limit in the speed limit zone.

5. The speed control apparatus of claim 3, wherein when it is determined that the type of the speed limit zone is the curve zone, the controller is configured to extract a curvature of a curved road from the navigation information, determines a speed limit for the curvature based on a speed limit table according to a preset curvature, and sets the speed limit for the curvature as a speed limit in the speed limit zone.

6. The speed control apparatus of claim 1, wherein the controller is configured to:
collect speed change time, speed variation, and a speed change completion position per speed limit zone type in the state where the forward vehicle following function is not activated
calculate acceleration per speed limit zone type from the speed change time and the speed variation per speed limit zone type, and
store the acceleration and the speed change completion position per speed limit zone type as the driver propensity data.

7. The speed control apparatus of claim 6, wherein the controller is configured to store the acceleration and the speed change completion position per speed limit zone type using a moving average method.

8. The speed control apparatus of claim 6, wherein the controller is configured to calculate the speed change start position using the current speed of the vehicle, the speed limit in the speed limit zone, and the acceleration and the speed change completion position corresponding to the speed limit zone, and controls the speed of the vehicle when the vehicle reaches the speed change start position.

9. A speed control method comprising:
a driver propensity data management operation of storing acceleration and a speed change completion position per speed limit zone type as driver propensity data in a state in which a forward vehicle following function is not activated;
a speed limit zone type determination operation of determining a type of a speed limit zone using navigation information;
a speed comparison operation of determining whether a current speed of a vehicle is greater than a speed limit in the speed limit zone according to the type of the speed limit zone; and
a speed control operation of identifying acceleration and a speed change completion position corresponding to the speed limit zone from the driver propensity data according to the type of the speed limit zone and of controlling the speed of the vehicle by calculating a speed change start position of the vehicle using the acceleration and the speed change completion position when the current speed of the vehicle is greater than the speed limit in the speed limit zone.

10. The speed control method of claim 9, wherein each of the speed change start position and the speed change completion position is a position that is a certain distance apart from a start position of the speed limit zone.

11. The speed control method of claim 9, wherein the speed limit zone a speed-camera speeding detection zone or a curve zone.

12. The speed control method of claim 11, wherein the speed control method further comprising: extracting a speed limit in the speed-camera speeding detection zone from the navigation information and setting the extracted speed limit as a speed limit in the speed limit zone when it is determined that the speed limit zone is the speed-camera speeding detection zone.

13. The speed control method of claim 11, wherein the speed control method further comprising: extracting a curvature of a curved road from the navigation information, determining a speed limit for the curvature based on a speed limit table according to a preset curvature, and setting the speed limit for the curvature as a speed limit in the speed limit zone when it is determined that the type of the speed limit zone is the curve zone.

14. The speed control method of claim 9, wherein the driver propensity data management operation collects a speed change time, speed variation, and a speed change completion position per speed limit zone type in the state where the forward vehicle following function is not activated, calculates acceleration per speed limit zone type from the speed change time and the speed variation per speed limit zone type, and stores the acceleration and the speed change completion position per speed limit zone type as the driver propensity data.

15. The speed control method of claim 12, wherein the driver propensity data management operation stores the acceleration and the speed change completion position per speed limit zone type using a moving average method.

16. The speed control method of claim 12, wherein the speed control operation calculates the speed change start position using the current speed of the vehicle, the speed limit in the speed limit zone, and the acceleration and the speed change completion position corresponding to the speed limit zone, and controls the speed of the vehicle when the vehicle reaches the speed change start position.

17. A speed control apparatus comprising:
a driver propensity data manager configured to store acceleration and a speed change completion position per speed limit zone type as driver propensity data in a state in which a forward vehicle following function is not activated;
a speed limit zone type determinator configured to determine a type of a speed limit zone using navigation information;
a speed comparator configured to determine whether a current speed of a vehicle is greater than a speed limit in the speed limit zone according to the type of the speed limit zone; and
a speed controller configured to identify acceleration and a speed change completion position corresponding to the speed limit zone from the driver propensity data according to the type of the speed limit zone and to control the speed of the vehicle by calculating a speed change start position of the vehicle using the acceleration and the speed change completion position when the current speed of the vehicle is greater than the speed limit in the speed limit zone.

18. The speed control apparatus of claim 17, wherein the driver propensity data manager collects speed change time, speed variation, and a speed change completion position per speed limit zone type in the state where the forward vehicle following function is not activated, calculates acceleration per speed limit zone type from the speed change time and the speed variation per speed limit zone type, and stores the acceleration and the speed change completion position per speed limit zone type as the driver propensity data.

19. The speed control apparatus of claim 18, wherein the propensity data manager is configured to store the acceleration and the speed change completion position per speed limit zone type using a moving average method.

20. The speed control apparatus of claim 18, wherein the speed controller is configured to calculate the speed change start position using the current speed of the vehicle, the speed limit in the speed limit zone, and the acceleration and the speed change completion position corresponding to the speed limit zone, and controls the speed of the vehicle when the vehicle reaches the speed change start position.
